(19) United States
(12) Patent Application Publication
(10) Pub. No.: US 2022/0108247 A1
(43) Pub. Date: Apr. 7, 2022

(54) TRANSIT SYSTEM FOR ADJUSTING DURATION TO RECONCILE ASSIGNMENT OF RESOURCES

(71) Applicant: Cubic Corporation, San Diego, CA (US)

(72) Inventor: Wesley Haworth, San Diego, CA (US)

(21) Appl. No.: 17/492,484

(22) Filed: Oct. 1, 2021

Related U.S. Application Data
(60) Provisional application No. 63/086,383, filed on Oct. 1, 2020.

(51) Int. Cl. G06Q 10/06; G06K 7/10; G06Q 30/02; G07C 9/29; G06Q 50/26; G07C 9/15

(52) U.S. Cl. CPC G06Q 10/06315; G06K 7/10297; G06Q 30/0201; G06Q 2240/00; G06Q 50/265; G07C 9/15; G06Q 30/0202; G07C 9/29

(57) ABSTRACT

A transit system for adjusting duration to reconcile the assignment of resources is provided. The system comprises a gate comprising a processing unit configured to read and verify whether RFID credentials presented at the gate match with RFID credentials that are denied access to the transit system. The system further comprises a rider profile module configured to create profiles for riders, the profiles comprising ride history, frequency of rides, allocation of resources associated with ride(s), the number of times riders have been denied access to the transit system. The system comprises a machine learning module configured to determine the travel behavior for the riders, a scoring module configured to assign scores to the riders, and a reconciliation module configured to adjust the duration to reconcile assignment of resources for the riders based on the score of the riders.

### CROSS-REFERENCE TO RELATED APPLICATIONS

This application claims the benefit of and is a non-provisional of co-pending U.S. Provisional Application Ser. No. 63/086,383 filed on Oct. 1, 2020, which is hereby expressly incorporated by reference in its entirety for all purposes.

### BACKGROUND

The disclosure relates to public transit systems and, but not by way of limitation, to adjusting duration to reconcile assignment of resources in transit systems.

Turnstile gates have been in use for a long time. In the turnstile gates, an access card is presented at a Radio-frequency identification (RFID) reader present in the gate. If RFID credentials associated with the access card are determined to be valid, the gates open, or else the gates do not open. To determine if the RFID credentials are valid, the RFID credentials have to pass a set of criteria set by service providers issuing the RFID credentials. The processing to be performed at the gate is entailed to be quick so that the experience of passengers can be enhanced.

As more and more riders pass the turnstile gates, more access cards are presented at the transit gates. As the number of riders increases, the processing of the number of RFID cards also increases. This in turn increases the burden on networks associated with the processing of the RFID credentials. Further, the bandwidth entailed for the processing of the RFID credentials increases. If a rider has a routine to pass through the gates daily, the number of access card transactions associated with the rider will further increase, thereby leading to the increased burden on networks and increased usage of bandwidth for processing. The network burden and the bandwidth usage further increases for a greater number of riders who travel daily.

### SUMMARY

A transit system for adjusting duration to reconcile assignment of resources is provided. The system comprises a gate comprising a processing unit configured to read and verify whether RFID credentials presented at the gate match with RFID credentials in a list of RFID credentials which are denied access to the transit system. The system further comprises a rider profile module configured to create profiles for a plurality of riders, the profiles comprising ride histories, frequency of rides, allocation of resources associated with rides taken by the plurality of riders, a number of times the plurality of riders has been denied access to the transit system. The system comprises a machine learning module configured to determine travel behavior for the plurality of riders, a scoring module configured to assign a score to the plurality of riders, and a reconciliation module configured to adjust duration to reconcile allocation of resources for the plurality of riders based on the score of the plurality of riders.

In one embodiment, a transit system for adjusting duration to reconcile assignment of resources is provided. The system comprises a gate comprising optionally a movable barrier, a Radio Frequency Identification (RFID) card reader coupled with the movable barrier, a processing unit coupled with the movable barrier and the RFID card reader, wherein the processing unit is configured to read a set RFID credentials when the RFID credentials are presented to the RFID card reader by a plurality of riders, verify whether the RFID credentials belong to a list of RFID credentials, wherein the list of RFID credentials comprise RFID credentials which are denied access to the transit system. The transit system further comprises a rider profile module configured to create profiles for the plurality of riders, wherein the profiles of the plurality of riders comprises ride histories for the plurality of riders, frequency of rides taken by the plurality of riders, allocation of resources associated with rides taken by the plurality of riders, a number of times the plurality of riders has been denied access to the transit system based on the allocation of resources. The transit system further comprises a machine learning module configured to generate a machine learning model to determine travel behavior for the plurality of riders based on the profiles for the plurality of riders, a scoring module configured to assign a score to the plurality of riders based on the travel behavior for the plurality of riders, a reconciliation module configured to adjust duration to reconcile assignment of resources for the plurality of riders based on the score of the plurality of riders.

In another embodiment, a method for adjusting duration to reconcile assignment of resources. The method comprising reading a set RFID credentials when the RFID credentials are presented to a RFID card reader by a plurality of riders, verifying whether the RFID credentials belong to a list of RFID credentials, wherein the list of RFID credentials comprise RFID credentials which are denied access to the transit system, creating profiles for the plurality of riders, wherein the profiles for the plurality of riders comprises ride histories for the plurality of riders, frequency of rides taken by the plurality of riders, and allocation of resources associated with rides taken by the plurality of riders, a number of times the plurality of riders has been denied access to the transit system based on the allocation of resources. The method further comprises generating a machine learning model to determine travel behavior for the plurality of riders based on the profiles for the plurality of riders, assigning a score to the plurality of riders based on the travel behavior for the plurality of riders, adjusting duration to reconcile assignment of resources for the plurality of riders based on the score of the plurality of riders.

In another embodiment, a non-transitory computer-readable medium having instructions embedded thereon for adjusting duration to reconcile assignment of resources, wherein the instructions, when executed by a plurality of processors, cause the plurality of processors to:
reading a set RFID credentials when the RFID credentials are presented to a RFID card reader by a plurality of riders,
verifying whether the RFID credentials belong to a list of RFID credentials, wherein the list of RFID credentials comprise RFID credentials which are denied access to the transit system,
creating profiles for the plurality of riders, wherein the profiles for the plurality of riders comprises ride histories for the plurality of riders, frequency of rides taken by the plurality of riders, and allocation of resources associated with rides taken by the plurality of riders, a number of times the plurality of riders has been denied access to the transit system based on the allocation of resources,
generating a machine learning model to determine travel behavior for the plurality of riders based on the profiles for the plurality of riders;
assigning a score to the plurality of riders based on the travel behavior for the plurality of riders;
adjusting duration to reconcile assignment of resources for the plurality of riders based on the score of the plurality of riders.

Further areas of applicability of the present disclosure will become apparent from the detailed description provided hereinafter. It should be understood that the detailed description and specific examples while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates an exemplary embodiment of a transit system, in accordance with one embodiment of the present disclosure.

FIG. 2 illustrates a perspective view of a gate array, in accordance with one embodiment of the present disclosure.

FIG. 3 illustrates a transit system, in accordance with one embodiment of the present disclosure.

FIG. 4 illustrates a block diagram of a gate in accordance with one embodiment of the present disclosure.

FIG. 5 illustrates a block diagram of the backend system, in accordance with one embodiment of the present disclosure.

FIG. 6 illustrates a simplified block diagram for adjustment of the reconciliation duration in accordance with one embodiment of the present disclosure.

FIG. 7 illustrates a flowchart describing a method for adjusting duration to reconcile assignment of resources.

FIG. 8A-8C illustrates a flowchart describing exemplary embodiment for three riders.

In the appended figures, similar components and/or features may have the same reference label. Further, various components of the same type may be distinguished by following the reference label by a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

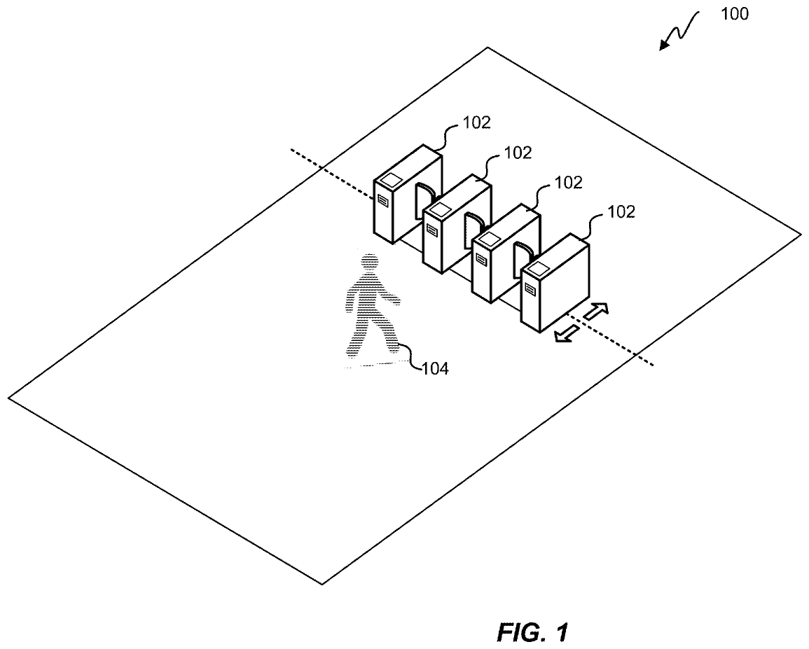

Referring to FIG. 1, illustrates an exemplary embodiment of a transit system 100, in accordance with some embodiment of the present disclosure. The transit system 100 shows several turnstile gates 102. A rider 104 walks towards gate 102, presents a set of RFID credentials at an RFID reader available at gate 102. If the set of RFID credentials are valid, gate 102 opens and rider 104 passes through. On the other hand, if the set of RFID credentials are not valid, gate 102 does not open and rider 104 is denied access through gate 102. The RFID credentials can be in the form of an access card or can be stored on a smart device available with the rider 104. The transit system 100 can be used for any public transport, for example, can be present at a bus station, railway station, etc. The validity of the set of RFID credentials depends on the validity of the access card which is pre-defined by an issuer of the access card.

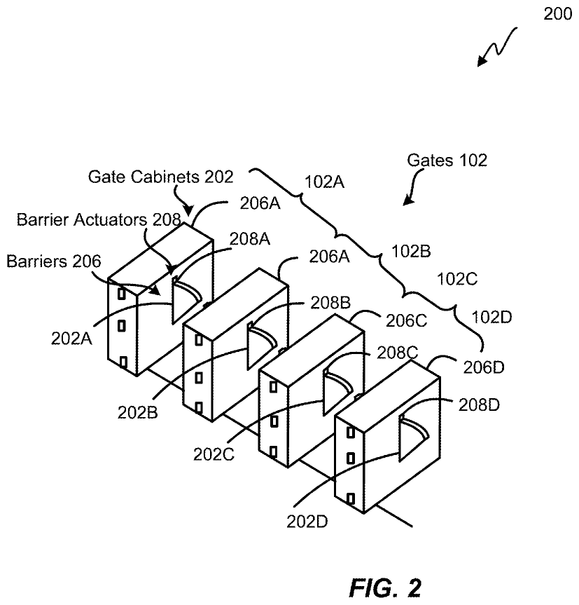

FIG. 2 shows a perspective view of a gate array 200, according to some embodiment of the present disclosure. In general, the gate array 200 can be similar to a regular gate line used in transportation systems or environments. For example, the gate array 200 can include several RFID-enabled gates (102A, 102B, 102C, 102D) and gate cabinets 202 (202A, 202B, 202C, 202D) (or other types of entry points) which create passageways through the gate array 200. In some embodiments, the RFID-enabled gates 102 can comprise movable barriers 206 (206A, 206B, 206C, 206D). The movable barriers 206 can comprise various types of physical barriers to impede access to a restricted access area, such as turnstiles, sliding doors, boom gates, or gate barriers. In some embodiments, rider 104 can swipe a ticket or an access card across an RFID card reader, for example, so that rider 104 can pass through the movable barriers 206 to gain access to a restricted access area from a non-restricted access area. Such an implementation can generally be effective to prevent or at least hinder fare evasion. In one embodiment, the access card is a credit card. When the access card does not have adequate resources (funds or amount) or is invalid, the movable barrier 206 can remain closed to prevent the individual from entering or accessing the restricted access area. The movable barrier 206 associated with gate 102 can be opened up by a barrier actuator 208 (208A, 208B, 208C, 208D) to permit the rider 104 passage upon successful validation of the set of RFID credentials by the RFID card reader. Some embodiments of the gate do not have a movable barrier at all.

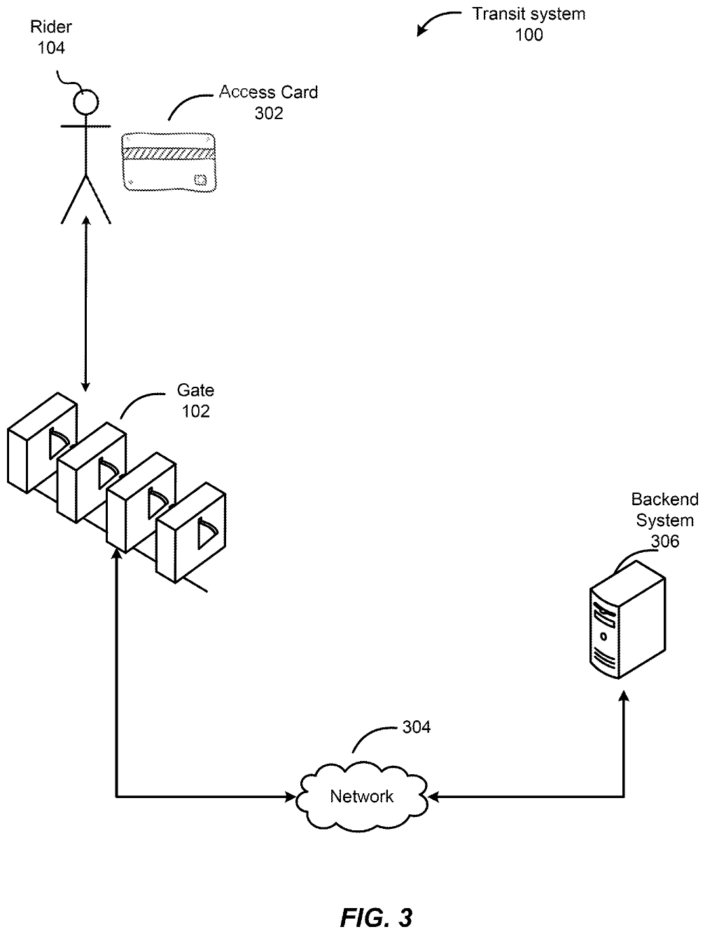

Referring to FIG. 3 now, illustrates a transit system 100, according to some embodiments of the present disclosure. The transit system 100 comprises rider 104 carrying an access card 302. Access card 302 is used to permit rider 104 to pass through gate 102. The access card 302 is used to authenticate rider 104 in terms of fees where gate 102 verifies whether access card 302 has adequate resources available into so as to permit rider 104 to permit pass through gate 102. If access card 302 does not have resources, gate 102 denies access to rider 104 through gate 102.

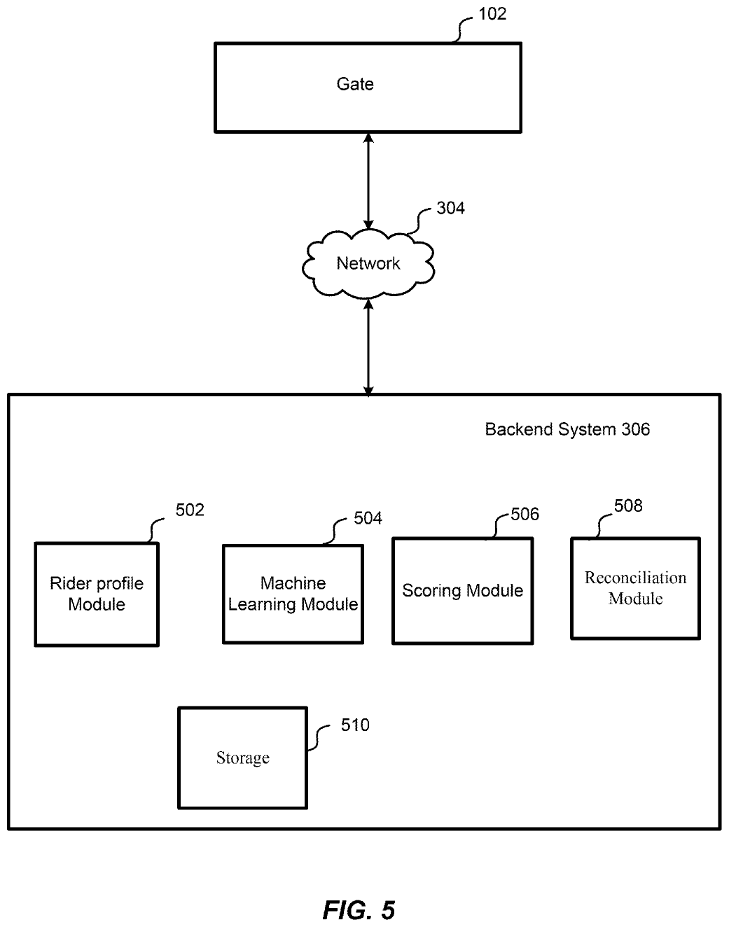

The decision to permit the opening of the gate takes place at gate 102 itself since this decision entails processing with no delay. However, there is certain processing that is entailed to be done at a backend system 306 via a network 304. For example, when the access card 302 is presented at the RFID card reader present at gate 102, resource allocation takes place. The allocation of resources is done by the backend system 306 which receives the credentials from the access card 302 and does further processing of the credentials. The processing of the access card 302 also entails adjusting a duration to reconcile the assignment of resources for the plurality of riders that passes through gate 102. The details regarding processing by the backend system 306 are further explained in FIG. 5.

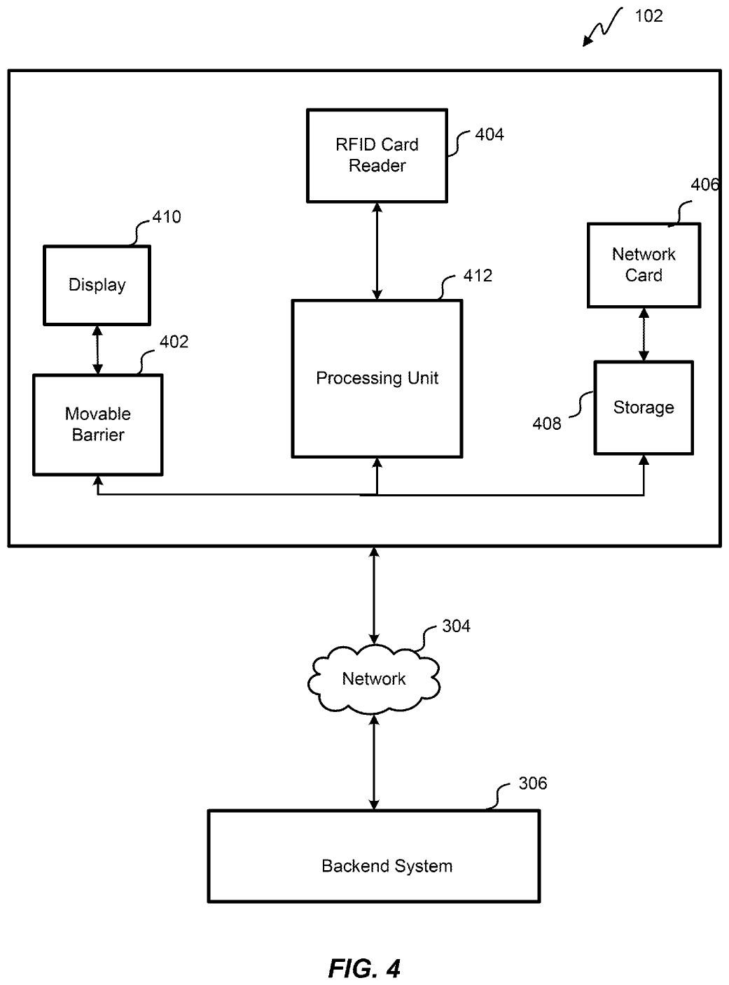

Referring to FIG. 4, a block diagram of gate 102 is illustrated, in accordance with some embodiment of the present disclosure. The gate 102 comprises a movable barrier 402, an RFID card reader 404, a network card 406, a storage 408, a display 410 and a processing unit 412 coupled with the movable barrier 402, the RFID card reader 404, the network card 406, the storage 408 and the display 410.

The RFID card reader 404 used herein can refer to any communication device that can transmit and/or receive wireless signals to or from an RFID tag. The term “RFID reader” can be used interchangeably with the terms “RFID transceiver”, “RFID transmitter”, “RFID receiver”, “transceiver”, “transmitter”, “receiver”, “transmitter antenna”, “receiver antenna”, and “antenna”. For example, in embodiments where several transceivers are disclosed as being positioned along the side of a gate cabinet and/or entry point, some embodiments can include transmitters and/or receivers being positioned along the side of the gate cabinet. Similarly, in embodiments where several antennas are disclosed as being positioned along the side of a gate cabinet and/or entry point, some embodiments can include RFID transceivers, RFID transmitters, and/or RFID receivers as being positioned along the side of the gate cabinet and/or entry point.

The RFID card reader 404 processes the set of RFID credentials presented at the RFID card reader 404 by rider 104 traveling using the transit system 100. As mentioned above, the set of RFID credentials can be in the form of access cards or can be stored in a smart device present with the rider 104. The access card can be a prepaid card, a credit card, etc. The smart device can include a smartphone, a smartwatch, a tablet, a laptop, etc. The RFID card reader 404 applies radio-frequency identification (RFID) techniques to automatically identify RFID credentials.

The RFID card reader 404 is coupled with the processing unit 412. The processing unit 412 verifies whether the set of RFID credentials presented at the RFID card reader match with a set of RFID credentials in a list of RFID credentials. The list of RFID credentials is stored in storage 408 and comprises a list of RFID credentials that are not permitted to access the transit system 100. This list of RFID credentials can be predefined by an issuer of the access card. The access to the riders can be denied due to reasons not limited to, for example, non-payment of previous rides by the rider, a type of access card not permitted by the service providers for traveling, etc. In one embodiment, the list of RFID credentials stored in storage 408 can include a list of RFID credentials that are permitted to pass through gate 102.

The processing unit 412 also verifies whether there are adequate resources available with rider 104 for using the transit system 100. The available resources can be verified when the access card 302 is presented at the RFID card reader 404. If the resources are above a pre-defined threshold value, the processing unit 412 permits the opening of the movable barrier 402 such that rider 104 can pass through gate 102. However, if the resources are below a pre-defined threshold value, the processing unit 412 denies opening of the movable barrier 402. In one embodiment, the resources available with rider 104 being presented to rider 104 on the display 410 present at gate 102. The processing unit 412 also verifies the validity of the access card. The validity of the access card is pre-defined by an issuer of the access card. If the access card is valid, processing unit 412 permits the opening of gate 102 and if the access card is not valid, the processing unit 412 denies opening of gate 102.

Gate 102 further comprises a network card 406 that lets the gate 102 exchange data with the backend system 306 over the network 304. In one embodiment, the data can be exchanged with servers of the service providers allocating resources (for example banks). The backend system 306 helps generate profiles for the riders passing through gate 102 and predict the travel behavior for the riders for future uses. More details about this will be explained below with respect to FIG. 5.

Referring to FIG. 5, a block diagram of the backend system 306 is illustrated, in accordance with some embodiment of the present disclosure. The backend system 306 comprises a rider profile module 502, a machine learning module 504, a scoring module 506, a reconciliation module 508, and a storage 510.

The rider profile module 502 is configured to create profiles for the plurality of riders using the transit system 100. The profile of rider 104 is created over a period of time. For example, as a rider travels through gate 102, the rider profile module 502 creates profiles of the rider and temporarily store the profile of the rider in a storage 510. In some embodiments, the profile may be deleted after interaction has not occurred with the transit system for a period of time. The profile of rider 104 is created based on certain inputs received from the transit system 100. For example, the profile of the rider 104 comprises a ride history of the rider 104, frequency of rides taken by the rider 104, allocation of resources associated with ride(s) taken by the rider 104, several times the rider 104 has been denied access to the transit system 100 based on the allocation of resources, etc. The profile of the rider 104 is not restricted to inputs mentioned here and can include other inputs as well.

The ride history of rider 104 comprises the riding details of rider 104, for example, a source and a destination station of rider 104, whether rider 104 has a fixed source and a fixed destination station, and also whether rider 104 using the transit system 100 at a fixed time daily, the total resources allocated to the rider 104 before and after ride(s) taken by the rider 104, resources available with the rider 104 before and after ride(s) taken by the rider 104.

The frequency of rides taken by rider 104 includes the number of rides taken by rider 104. This can include the number of rides taken by the rider 104 in a predefined period, for example, in a month or in a year. For example, some of the riders travel daily while other riders travel few days a month. Thus, the rider profile module 502 tracks the number of rides taken by riders passing through the gate and stores it in the storage 510.

The allocation of resources associated with ride(s) taken by rider 104 can include resources available with rider 104 before and after taking the ride. The resources available with rider 104 before taking the ride helps the processing unit 412 verify whether rider 104 has adequate resources to take the ride. On the other hand, the resources available with rider 104 after taking the ride indicate whether rider 104 has adequate resources available to take the next ride.

The number of times the rider 104 has been denied access to the transit system 100 based on the allocation of resources is also tracked by the rider profile module 502. In one embodiment, rider 104 can be denied access to the transit system 100 if the set of RFID credentials presented by rider 104 from an access card are present in the list of RFID credentials that are not permitted to access the transit system 100. In another embodiment, the rider 104 can be denied access to the transit system 100 if rider 104 does not have adequate resources available to take the ride. In another embodiment, rider 104 can be denied access to the transit system 100 if the profile of the rider 104 is such that rider 104 does not maintain adequate resources to access the transit system 100, as identified from a travel behavior of rider 104 (explained later).

The profile of rider 104 as generated by the rider profile module 502 is provided to the machine learning module 504. The machine learning module 504 includes machine learning models which take as input from the rider profile module 502 and apply machine learning techniques to predict the travel behavior for the rider 104. The machine learning module 504 predicts the travel behavior for the riders passing through the gate based on the profile received for the riders.

The travel behavior involves learning travel patterns for the riders based on the rider profiles generated by the rider profile module 502. The travel patterns can involve a routine followed by a rider. The travel patterns can be identified from the profile for the riders created by the rider profile module 502. The travel behavior of a rider can help determine the next ride analysis of the rider. The next ride analysis of the rider can involve the next date of travel of the rider in the transit system 100. For example, if it is determined from the profile of the rider that the rider passes every Tuesday through gate 102, the machine learning module 504 predicts the next date of travel of the rider as Tuesday and can identify resources available with the rider. Similarly, based on the predictions, the machine learning module 504 can identify when to allocate resources to the rider, whether to adjust reconciliation duration for allocating resources to the rider and whether to adjust the resource threshold for the rider. In one embodiment, the machine learning module is configured to determine a likelihood for the plurality of riders being denied access to the transit system based on travel behavior for the riders.

To adjust the reconciliation duration, the riders is assigned a score by the scoring module 506. The score is based on the travel behavior for the riders as determined from the machine learning module 504. The score of the riders will increase based on a strength of the profiles for the riders. For example, if a rider has a well-established travel history, i.e., the rider travels frequently and has a well-defined travel behavior, the score of the rider is more as compared to a rider who travels less and does not have a well-defined travel behavior. Thus, a higher score would indicate that the rider has a stronger profile than the rider having a lower score. A stronger profile rider can be more trustworthy in the transit system 100 than the rider having a lower score. In one example embodiment, the longer the duration, the more transaction costs are saved by accumulating multiple transactions into a single transaction with a single fee.

Based on the score assigned to the riders by the scoring module 506, the reconciliation module 508 is configured to adjust the reconciliation duration for the allocation of resources. The reconciliation duration for a rider with the higher score is extended while the reconciliation duration for a rider with the lower score is shortened. In other words, time to allocate the resources for the rider with a higher score is extended than the rider with a lower score.

Thus, as rider 104 creates a stronger rider profile by taking more rides and establishing a ride history, the duration for allocating resources to rider 104 increases. Since the allocation of resources takes place from the backend system 306 over network 304, with the extension of reconciliation duration, the burden on network 304 to allocate resources decreases. Further, the bandwidth for the network 304 entailed to allocate the resources are also saved.

In one embodiment, based on the score of the rider 104, a resource threshold also changes. For example, for a rider having a higher score, the resource threshold increases. On the other hand, for the rider with a low score, the resource threshold decreases. Thus, if rider 104 has a higher score, a threshold for allocating several resources increases, and on the other hand if rider 104 has a lower score, a threshold for allocating several resources decreases.

In one embodiment, based on the score of the rider 104, both the reconcile duration and the reconcile threshold can be adjusted. For example, if rider 104 has a higher score, the reconciliation duration for the rider is extended and the resource threshold is increased. On the other hand, if the rider has a lower score, the reconciliation duration of the rider is shortened, and the resource threshold is decreased.

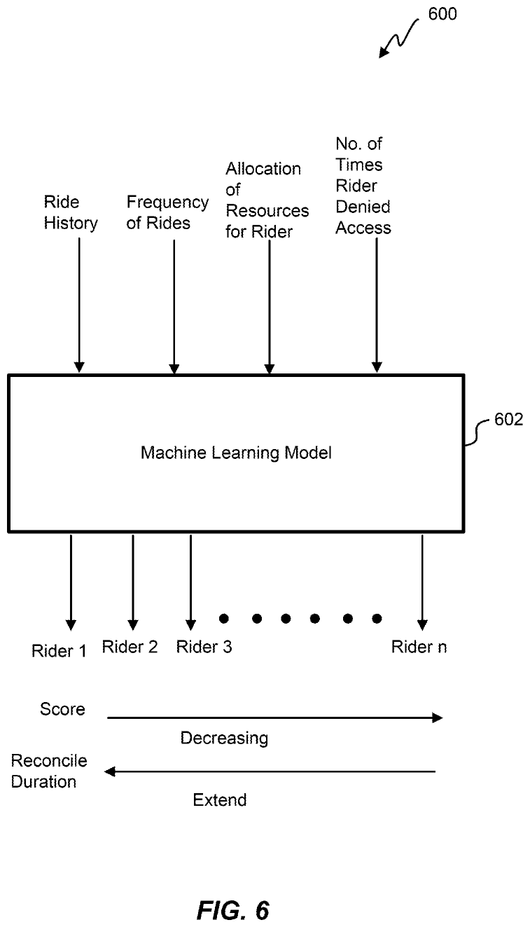

Referring to FIG. 6 now, a simplified block diagram 600 illustrating adjustment of the reconciliation duration is shown, in accordance with some embodiment of the present disclosure. The machine learning model 602, present in the machine learning module 504, receives as input a profile of the rider 104 as created by the rider profile module 502. The profile of rider 104 includes, for example, is not limited to, a ride history, frequency of rides taken by the rider 104, allocation of resources for rider 104, and the number of times rider 104 is denied access through the gate. Although inputs of a rider 104 are shown, the machine learning model 602 receives profiles of the riders passing through the gate 102.

The machine learning model 602 sorts the riders based on a score assigned to the riders by the scoring module 506. The score of riders can be based on the travel behavior for the riders as predicted by the machine learning model 602. As the score of the riders decreases from rider 1 to rider n, the reconciliation duration for allocating the resources extends from rider n to rider 1. Thus, as rider 1 has the highest score, the reconciliation duration for allocating the resources is maximum for rider 1. On the other hand, rider n has the lowest score and hence the reconciliation duration for allocating the resources is minimum for rider n.

In one embodiment, instead of the reconciliation duration, FIG. 6 can include a resource threshold, as explained above. Thus, for rider 1 with the highest score, the resource threshold increases, and for rider n with the lowest score, the resource threshold decreases. In another embodiment, FIG. 6 can include the reconciliation duration and the resource threshold. Thus, for rider 1 with the highest score, the resource threshold increases, and the reconciliation duration is extended. On the other hand, for the rider n with the lowest score, the resource threshold decreases, and reconciliation duration is shortened.

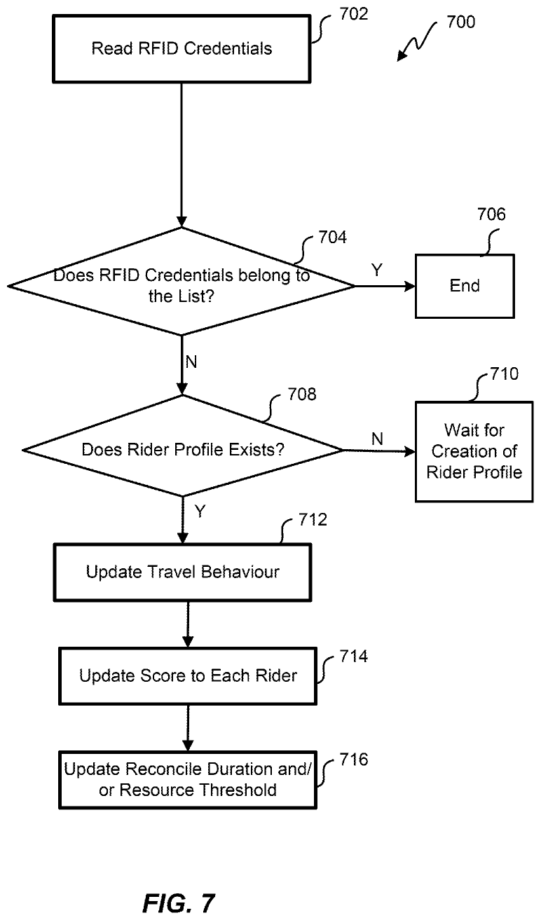

Referring to FIG. 7 now, a method 700 for adjusting duration to reconcile assignment of resources is illustrated, in accordance with some embodiment of the present disclosure. In a transit system 100, a rider 104 presents an access card for passing through the gate 102 present at stations. Gate 102 processes the access cards to immediately make a decision whether to permit rider 104 to pass through gate 102. To pass through the gate, there are certain resources entailed to be allocated to rider 104. When rider 104 passes through gate 102, allocation of resources takes place. The resources are allocated by the backend system 306. As the number of riders increases, the processing entailed by the backend system 306 increases. This burdens the backend system 306 and also the bandwidth of a network entailed to access the backend system 306 increases. The present disclosure overcomes this problem by adjusting a reconciliation duration for the allocation of resources for riders based on the travel behavior of the riders.

Method 700 begins at block 702, where the set of RFID credentials are read when an access card available with the rider is presented at the gate. Any rider passing through the gate needs to present an access card available with the rider. The processing unit 412, at block 704, verifies whether the set of RFID credentials are valid. For this, processing unit 412 verifies whether the set of RFID credentials matches with the set of RFID credentials in a list of RFID credentials that are to be denied access to the transit system 100. If the set of RFID credentials matches with the RFID credentials in the list of RFID credentials that are denied access to the transit system 100, method 700 ends (block 706).

If the set of RFID credentials do not match with RFID credentials in the list of RFID credentials that are not denied access to the transit system 100, method 700 proceeds to block 708 where it is determined whether a rider profile exists. The rider profile comprises parameters like ride histories for the plurality of riders, frequency of rides taken by the plurality of riders, allocation of resources associated with ride(s) taken by the plurality of riders, and several times a rider has been denied access to the transit system 100 based on the allocation of resources. If the rider profile does not exist, the method waits for the creation of the rider profile (block 710). Until the rider profile is created, method 700 keeps building the profile of the rider.

Once the profile of rider 104 is generated, method 700 proceeds to block 712 where the travel behavior of rider 104 is updated. Thus, from the rider profile, using machine learning techniques, the travel behavior of rider 104 is predicted. The travel behavior of rider 104 involves learning a routine for rider 104 and predicting when will rider 104 travel next. Whenever rider 104 takes the ride, the rider profile and hence the travel behavior is updated.

The plurality of riders is assigned a score based on the predicted travel behavior. The score is assigned based on how strong the travel behavior of the rider is. For example, if the rider has a well-established rider profile, i.e., the rider profile for a larger duration of time, it would be better to determine the travel behavior of the rider. In this case, such rider would be assigned a higher score as compared to the rider having a rider profile for a shorter duration of time. Whenever time the rider takes the ride, the rider profile, the travel behavior, and hence the score is updated at block 714.

Once the score is assigned to riders, the reconciliation duration/resource threshold is updated, at block 716. A rider with a higher score would have a longer reconciliation duration and a higher resource threshold as compared to the rider with a lower score. In other words, the rider having a rider profile for a larger duration of time is given the longer reconciliation duration for allocation of resources and the higher resource threshold.

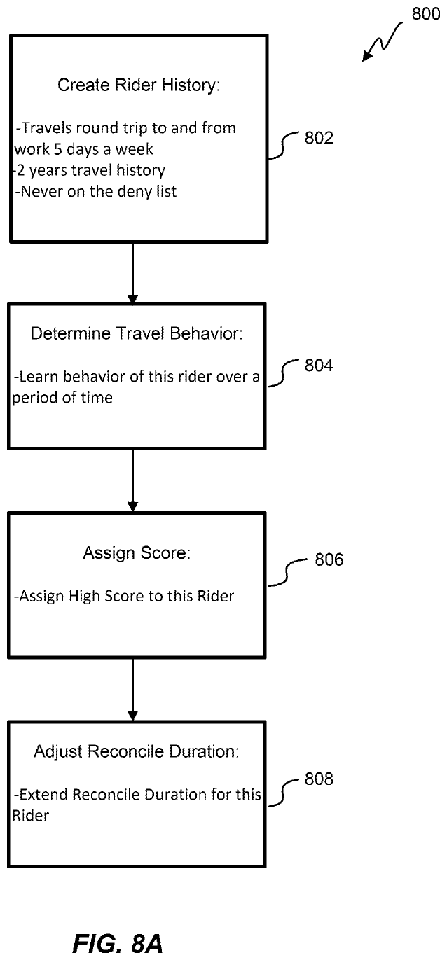

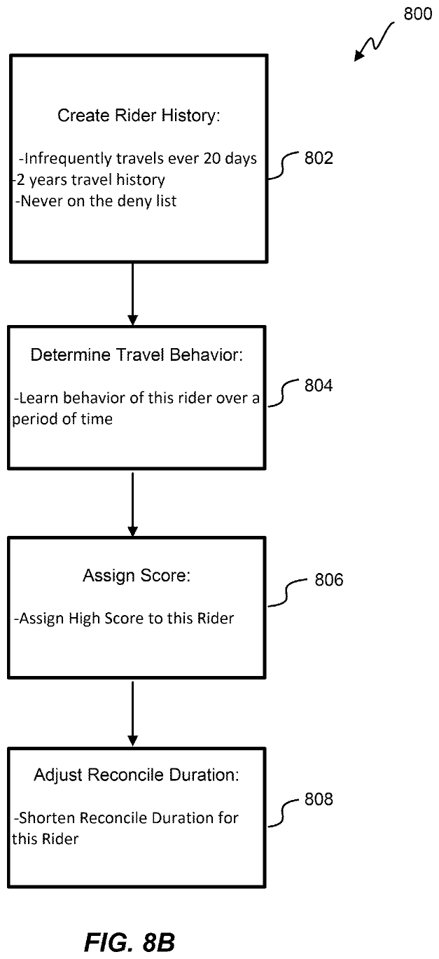

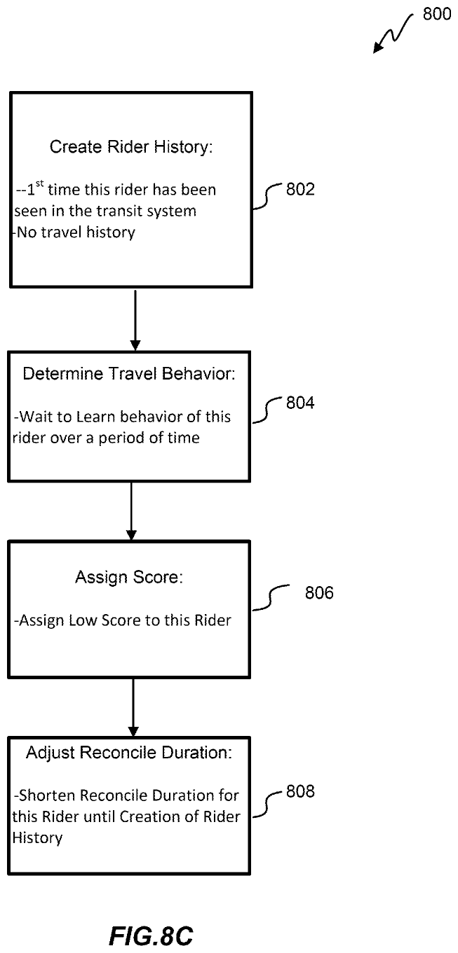

Referring to FIGS. 8A-8C now, a method 800 illustrating exemplary embodiment for three riders is shown, in accordance with some embodiment of the present disclosure. FIG. 8A describes a method for adjusting reconciliation duration for allocation of resources for rider 1, FIG. 8B describes the method for adjusting reconciliation duration for allocation of resources for rider 2, and FIG. 8C describes the method for adjusting reconciliation duration for allocation of resources for rider 3. Although three riders have been shown as an example, the presented disclosure is not limited to the number of riders.

Starting from FIG. 8A, method 800 for adjusting reconciliation duration for allocation of resources for rider 1 is illustrated in accordance with some embodiment of the present disclosure. At block 802, a rider history is created. Rider 1 travels round trip to and from work 5 days a week. In other words, rider 1 is a daily traveler and passes through the gate daily for 5 days a week. Further, Rider 1 has a travel history of 2 years and is not on a deny list. Thus, rider 1 has a well-defined rider profile established over 2 years. Based on the rider profile of rider 1, the travel behavior of rider 1 is learned at block 804 over a period of time. The travel behavior helps predict the travel routine of the rider 1. Now, since rider 1 has a well-established rider profile, rider 1 is assigned a higher score, at block 806. In other words, the transit system 100 assigns a higher score to rider 1 based on the learned travel behavior of rider 1. Since rider 1 has a higher score, the reconciliation duration for allocation of resources for rider 1 is extended, at block 808. This means rider 1 is given more time for the reconciliation of resources. In one embodiment, instead of or in addition to the reconciliation duration, the resource threshold is also increased for rider 1 since rider 1 has a higher score.

Referring to FIG. 8B now, a method 800 for adjusting reconciliation duration for allocation of resources for rider 2 is illustrated in accordance with some embodiment of the present disclosure. At block 802, a rider history is created. Rider 2 travels infrequently for 20 days in a month. Further, rider 2 has a travel history of 2 years and is not on a deny list. Thus, rider 2 does not have a well-defined rider profile as compared to rider 1. Based on the rider profile of rider 2, the travel behavior of rider 2 is learned at block 804 over a period of time. The travel behavior helps predict the travel routine of the rider 2. Rider 2 is also assigned a higher score since rider 2 has a routine for traveling for 2 years, at block 806. In other words, the transit system 100 assigns a higher score to rider 2 based on the learned travel behavior of rider 2. Since rider 2 has a higher score, the reconciliation duration for allocation of resources for rider 2 is extended, at block 808. This means rider 2 is given more time for reconciliation of resources. In one embodiment, instead of or in addition to the reconciliation duration, the resource threshold is also increased for rider 2 since rider 2 has a higher score.

Referring to FIG. 8C now, a method 800 for adjusting reconciliation duration for allocation of resources for rider 3 is illustrated in accordance with some embodiment of the present disclosure. At block 802, a rider history is created. Rider 3 not once traveled through gate 102 and hence the transit system 100 does not recognize rider 3. Thus, rider 3 does not have a well-established rider profile. Based on the rider profile of rider 3, a travel behavior cannot be predicted, and hence, the transit system 100 waits to learn the travel behavior of rider 3 over a period of time. Thus, as rider 3 takes more rides, the rider profile is created and the travel behavior of rider 3 is learned over a period of time. The travel behavior helps predict the travel routine of the rider 3. Rider 3 is assigned a lower score, at block 806. Since rider 3 has a lower score, the reconciliation duration for allocation of resources for rider 2 is shortened, at block 808. This means rider 3 is given less time for reconciliation of resources. In one embodiment, instead of or in addition to the reconciliation duration, the resource threshold is also decreased for rider 3 since rider 3 has a lower score.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

What is claimed is:

1. A transit system for adjusting duration to reconcile assignment of resources, the transit system comprising:
a gate comprising:
a Radio Frequency Identification (RFID) card reader;
a processing unit coupled with the RFID card reader, wherein the processing unit is configured to:
read a set of RFID credentials when the set of RFID credentials are presented to the RFID card reader by a plurality of riders, and
verify whether the set of RFID credentials match with RFID credentials in a list of RFID credentials, wherein the list of RFID credentials comprises RFID credentials which are denied access to the transit system,
a rider profile module configured to create profiles for the plurality of riders, wherein the profiles for the plurality of riders comprises:
ride histories for the plurality of riders,
frequency of rides taken by the plurality of riders,
allocation of resources associated with rides taken by the plurality of riders,
a number of times the plurality of riders has been denied access to the transit system based on the allocation of resources, and
a machine learning module configured to generate a machine learning model to determine travel behavior for the plurality of riders based on the profiles for the plurality of riders;
a scoring module configured to assign scores to the plurality of riders based on the travel behavior for the plurality of riders; and
a reconciliation module configured to adjust duration to reconcile assignment of resources for the plurality of riders based on the scores of the plurality of riders.

2. The transit system for adjusting duration to reconcile assignment of resources, as recited in claim 1, wherein if a rider has a higher score, the reconciliation module is configured to extend the duration to reconcile assignment of resources and if a rider has a lower score, the reconciliation module is configured to shorten the duration to reconcile assignment of resources.

3. The transit system for adjusting duration to reconcile assignment of resources, as recited in claim 1, wherein the machine learning module is configured to predict a next ride for the plurality of riders based on the travel behavior for the riders.

4. The transit system for adjusting duration to reconcile assignment of resources, as recited in claim 1, wherein the machine learning module is configured to determine a likelihood for the plurality of riders being denied access to the transit system based on the travel behavior for the riders.

5. The transit system for adjusting duration to reconcile assignment of resources, as recited in claim 1, wherein the RFID credentials are provided through an access card.

6. The transit system for adjusting duration to reconcile assignment of resources, as recited in claim 5, wherein:
the processing unit is configured to verify validity of the access card, and
the validity of the access card is pre-defined by an issuer of the access card.

7. The transit system for adjusting duration to reconcile assignment of resources, as recited in claim 1, wherein the reconciliation module is configured to update the duration to reconcile assignment of resources based on update in travel behavior for the plurality of riders.

8. A method for adjusting duration to reconcile assignment of resources, the method comprising:
reading a set of RFID credentials when the set of RFID credentials are presented to a RFID card reader by a plurality of riders,
verifying whether the set of RFID credentials match with RFID credentials in a list of RFID credentials, wherein the list of RFID credentials comprises RFID credentials which are denied access to a transit system,
creating profiles for the plurality of riders, wherein the profiles for the plurality of riders comprises:
ride histories for the plurality of riders,
frequency of rides taken by the plurality of riders, and
allocation of resources associated with rides taken by the plurality of riders,
a number of times the plurality of riders has been denied access to the transit system based on the allocation of resources,
generating a machine learning model to determine travel behavior for the plurality of riders based on the profiles for the plurality of riders;
assigning scores to the plurality of riders based on the travel behavior for the plurality of riders; and
adjusting duration to reconcile assignment of resources for the plurality of riders based on the score of the plurality of riders.

9. The method for adjusting duration to reconcile assignment of resources, as recited in claim 8, wherein if a rider has a higher score, extending the duration to reconcile assignment of resources and if a rider has a lower score, shortening the duration to reconcile assignment of resources.

10. The method for adjusting duration to reconcile assignment of resources, as recited in claim 8, further comprising predicting a next ride for the plurality of riders based on the travel behavior of the riders.

11. The method for adjusting duration to reconcile assignment of resources, as recited in claim 8, further comprising determining a likelihood for the plurality of riders from being denied accessing the transit system based on travel behavior of the riders.

12. The method for adjusting duration to reconcile assignment of resources, as recited in claim 8, wherein the RFID credentials are provided through an access card.

13. The method for adjusting duration to reconcile assignment of resources, as recited in claim 12, further comprising verifying validity of the access card, wherein the validity of the access card is pre-defined by an issuer of the access card.

14. The method for adjusting duration to reconcile assignment of resources, as recited in claim 8, further comprising updating the duration to reconcile assignment of resources based on update in travel behavior for the plurality of riders.

15. A non-transitory computer-readable medium having instructions embedded thereon for adjusting duration to reconcile assignment of resources, wherein the instructions, when executed by a plurality of processors, cause the plurality of processors to:
reading a set of RFID credentials when the set of RFID credentials are presented to a RFID card reader by a plurality of riders,
verifying whether the set of RFID credentials match with RFID credentials in a list of RFID credentials, wherein the list of RFID credentials comprises RFID credentials which are denied access to a transit system,
creating profiles for the plurality of riders, wherein the profiles for the plurality of riders comprises:
ride histories for the plurality of riders,
frequency of rides taken by the plurality of riders, and
allocation of resources associated with rides taken by the plurality of riders,
a number of times the plurality of riders has been denied access to the transit system based on the allocation of resources,
generating a machine learning model to determine travel behavior for the plurality of riders based on the profiles for the plurality of riders;
assigning scores to the plurality of riders based on the travel behavior for the plurality of riders; and
adjusting duration to reconcile assignment of resources for the plurality of riders based on the scores for the plurality of riders.

16. The non-transitory computer-readable medium for adjusting duration to reconcile assignment of resources, as recited in claim 15, wherein if a rider has a higher score, extending the duration to reconcile assignment of resources and if a rider has a lower score, shortening the duration to reconcile assignment of resources.

17. The non-transitory computer-readable medium for adjusting duration to reconcile assignment of resources, as recited in claim 15, further comprising predicting a next ride for the plurality of riders based on the travel behavior of the plurality of riders.

18. The non-transitory computer-readable medium for adjusting duration to reconcile assignment of resources, as recited in claim 15, further comprising determining a likelihood for the plurality of riders from being denied accessing the transit system based on travel behavior of the riders.

19. The non-transitory computer-readable medium for adjusting duration to reconcile assignment of resources, as recited in claim 15, wherein the RFID credentials are provided through an access card.

20. The non-transitory computer-readable medium for adjusting duration to reconcile assignment of resources, as recited in claim 15, further comprising updating the duration to reconcile assignment of resources based on update in travel behavior for the plurality of riders.
